(19) United States
(12) Patent Application Publication
(10) Pub. No.: US 2010/0269504 A1
(43) Pub. Date: Oct. 28, 2010

(54) Coating system and method for reducing coking and fuel system fouling

(75) Inventors: Marc E. Gage, Feeding Hills, MA (US); Haralambos Cordatos, Colchester, CT (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Hamilton Sunstrand Corporation, Rockford, IL (US)

(21) Appl. No.: 12/386,904

(22) Filed: Apr. 24, 2009

(51) Int. Cl. F02C 7/22; B05D 7/22; B05D 3/00

(52) U.S. Cl. 60/734; 427/235; 427/372.2

(57) ABSTRACT

A fuel system for delivering fuel to an engine includes a fuel tank, a hot section in fluid communication with the fuel tank for delivering fuel for combustion by the engine, and a coating applied to at least a portion of the hot section for reducing fuel coking. The coating includes a fluorine functional group and a silane functional group.

### BACKGROUND

The present invention relates to fuel systems and associated methods of manufacture, and more particularly to those suitable for use with gas turbine engines.

Gas turbine engines, such as those suitable for use with aircraft, generally use hydrocarbon-based fuels. The elevated temperatures at which prior art gas turbine engine fuel systems operate-up to approximately 121° C. (250° F.)—an cause chemical reactions to occur within the fuel that can lead to the formation and deposition of carbonaceous materials, which is referred to in the art as fuel “coking”. Coking is often catalyzed by surfaces of fuel system components wetted by hydrocarbon-based fuel, and some materials (e.g., copper) are more likely than others to catalyze coking. Once formed, carbonaceous materials can undesirably accumulate on fuel system components such as conduits, valve surfaces, filter screens, etc., and can lead to malfunctions and/or increased needs for repair or maintenance.

### SUMMARY

A fuel system for delivering fuel to an engine according to the present invention includes a fuel tank, a hot section in fluid communication with the fuel tank for delivering fuel for combustion by the engine, and a coating applied to at least a portion of the hot section for reducing fuel coking. The coating includes a fluorine functional group and a silane functional group.

### BRIEF DESCRIPTION OF THE DRAWINGS

FIG. 1 is a block diagram of an aircraft having a fuel system according to the present invention.

FIG. 2 is a cross-sectional view of a coated component of the fuel system.

FIG. 3 is a flow chart of one embodiment of a method of making the fuel system according to the present invention.

FIG. 4 is a flow chart of another embodiment of a method of making the fuel system according to the present invention.

### DETAILED DESCRIPTION

In general, the present invention provides a system and associated method of making a fuel system at least partially coated to reduce coking and fouling. In one embodiment, the coating comprises a silane functional group and a fluorine functional group. The fluorine functional group helps reduce the formation and deposition of carbonaceous material in the fuel system, and can help enable elevated fuel system operating temperatures (e.g., at least approximately 135° C. (275° F.)). The silane functional group helps promote adhesion of the fluorine functional group within the fuel system. Other coating compounds are utilized in alternative embodiments. In one embodiment of a method according to the present invention, fuel system components are assembled together and the coating is flushed through at least a portion of the assembled components. In another embodiment, discrete fuel system components are coated and then assembled together in the fuel system.

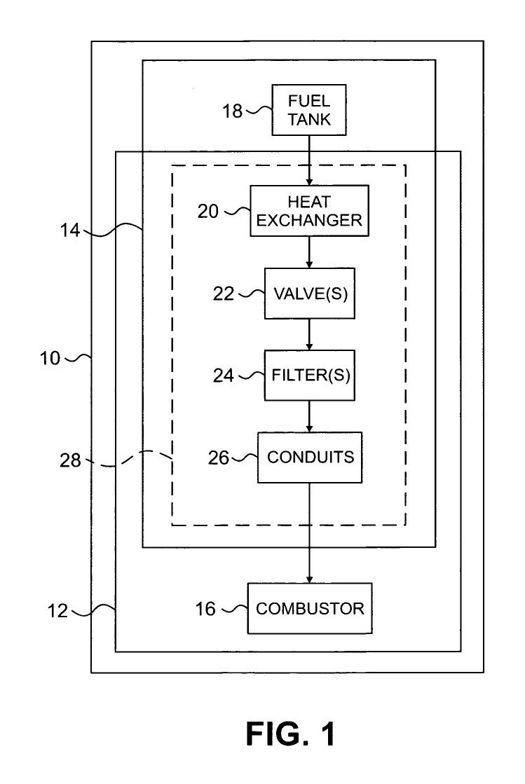

FIG. 1 is a block diagram of an aircraft 10 that includes a gas turbine engine 12 and a fuel system 14. The gas turbine engine 12 includes a combustor 16 that accepts fuel delivered by the fuel system 14 for combustion, in order to power the aircraft 10. The aircraft 10 and the gas turbine engine 12 can include additional components not specifically shown.

In the illustrated embodiment, the fuel system 14 includes a fuel tank 18, a heat exchanger 20, one or more valves 22, one or more filters 24, and suitable conduits 26. The fuel tank 18 is carried on the aircraft 10, and can store a suitable hydrocarbon-based fuel for the gas turbine engine 12, such as known fuel formulations like Jet A and Jet A-1 (defined by industry specification ASTM D 1655) or JP-8 (defined by military specification MIL-DTL-83133). The heat exchanger 20 (e.g., a fuel/oil heat exchanger) is fluidically connected to the fuel tank 18. The valves 22, the filters 24, and the conduits 26 are fluidically connected between the heat exchanger 20 and the combustor 16, in any suitable arrangement. It should be understood that the fuel system 14 illustrated in FIG. 1 is provided merely by way of example and not limitation. The fuel system 14 can include additional components not shown, such as a fuel pump and a fuel metering unit (FMU), and can have other configurations and arrangements as desired for particular applications.

During operation, thermal energy is transferred to fuel passing through the heat exchanger 20. Portions of the fuel system 14 from the heat exchanger 20 downstream to the combustor 16 of the gas turbine engine 12 are generally referred to as a hot section 28, which is designated in FIG. 1 by dashed lines. Fuel in the hot section 28 is generally at an elevated operating temperature, that is, it is at a temperature generally greater than room temperature or ambient temperature. In one embodiment, fuel in the hot section 28 has an operating temperature of at least approximately 135° C. (275° F.). In other embodiments, the fuel can have higher or lower operating temperatures.

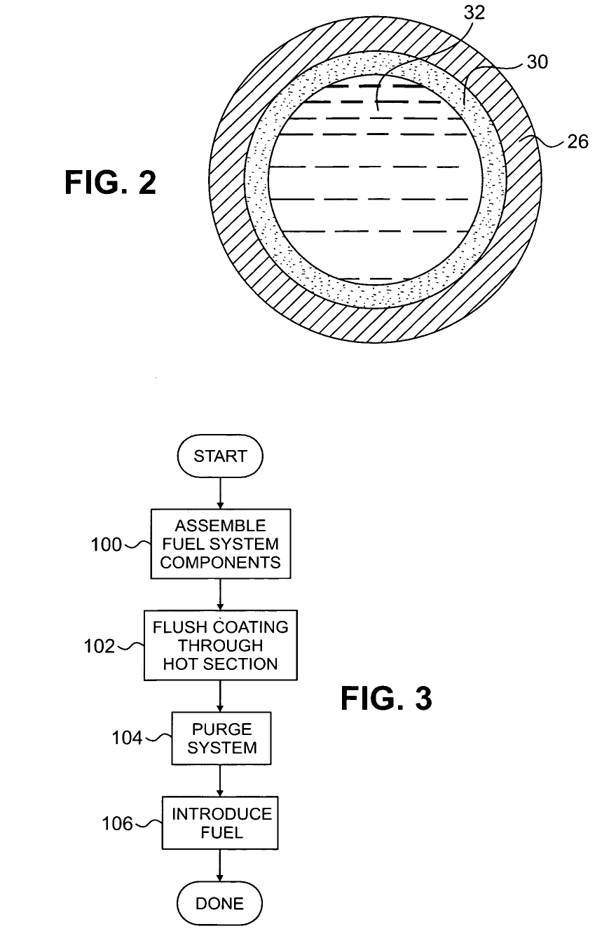

Portions of the fuel system 14 have a coating on surfaces exposed to fuel, which helps reduce a risk of coking by being relatively catalytically inactive with respect to typical hydrocarbon-based gas turbine engine fuels and also by reducing the ability of carbonaceous materials present in fuel from adhering to surfaces within the fuel system 14. The coating is generally fuel resistant, anti-fouling, relatively thin, has relatively good adhesion properties, is thermally stable at elevated gas turbine engine fuel system operating temperatures, and is relatively durable. FIG. 2 is a cross-sectional view of one of the conduits 26 of the fuel system 14 having a coating 30. In one embodiment, the coating 30 comprises a fluorine functional group and a silane functional group. The fluorine functional group can be a perfluoropolyether, polytetrafluoroethylene (PTFE) or another suitable fluoropolymer. The silane functional group can attach to the fluorine functional group to promote adhesion to surfaces of the fuel system 14. In one embodiment, the coating 30 having a fluorine functional group and a silane functional group is a Dow Corning® 2604 anti-fouling coating (available from Dow Corning Corp., Midland, Mich.), which has an anticipated thermal operating capacity of up to approximately 204° C. (400° F.). As shown in FIG. 2, a liquid, hydrocarbon-based fuel 32 is present within the conduit 26, which can be made of a metallic material. The coating 30 is located along interior surfaces of the conduit 26, and forms essentially a barrier between the fuel 32 and the metallic material of the conduit 26. It should be noted that FIG. 2 is not necessarily shown to scale.

In an alternative embodiment, the coating 30 is a fluorochemical acrylate, such as a 3M™ Novec™ EGC-1700 anti-wetting, repellent film (available from 3M Specialty Materials, St. Paul, Minn.). In another alternative embodiment, the coating 30 is a low molecular weight PTFE material, such as a MS-143H release agent/dry lubricant coating (available from Miller-Stephenson Chemical Co., Inc., Danbury, Conn.).

The coating 30 can be applied to other components of the fuel system 14 in a manner similar to that shown with respect to the conduit in FIG. 2. The coating 30 can be applied to any suitable thickness, though it is generally desirable to have the coating 30 be as thin as possible. The thickness of the coating 30 within the fuel system 14 can vary, and different portions of the fuel system 14 can have the coating 30 applied at different thicknesses. For example, in critical areas such as on screens of the filters 24 having clearances of approximately 0.0762 mm (0.003 inch), the coating 30 can be applied to a thickness of approximately 0.00762 mm (0.3 mils).

The fuel system 14 can be fabricated in a number of ways according to the present invention. FIG. 3 is a flow chart of one embodiment of a method of making the fuel system 14. As shown in FIG. 3, the method includes assembling components of the fuel system 14 to define at least a portion of a fuel flow path (step 100). Typically, step 100 will include assembling at least the hot section 28 of the fuel system 14, though greater or fewer components can be assembled as desired. In one embodiment, the coating is applied throughout the hot section 28 of the fuel system 14, from the heat exchanger 20 up to and optionally including portions of the combustor 16. Next, the coating 30 is flushed through the hot section 28 or other desired portions of the fuel system 14 (step 102). If the coating 30 is a Dow Corning® 2604 anti-fouling coating, it can be flushed through portions of the fuel system 14 at approximately room temperature (e.g., at temperatures less than about 60° C. (140° F.)) while maintaining a relatively low viscosity. In one embodiment, the entire fuel system 14 is assembled on the engine 12, and the coating 30 is flushed through the fuel system 14 in-situ. The valves 22 should generally be open for the flushing operation, and it is generally desirable to have screens of the filters 24 in place to be coated by the flushing operation. After the coating 30 has been flushed through desired portions of the fuel system 14, the fuel system 14 is purged (step 104). Purging the fuel system 14 helps to dry the coating 30 (e.g., by helping evacuate solvents), and can help remove excess coating material. The purge can be performed using pressurized air at approximately room temperature. Once the coating 30 is sufficiently dry, the fuel 32 can be introduced to the fuel system 14 (step 106). Operation of the fuel system 14 and the gas turbine engine 12 can then begin. It should be noted that the method of making the fuel system 14 described with respect to FIG. 3 can optionally include additional steps not specifically mentioned.

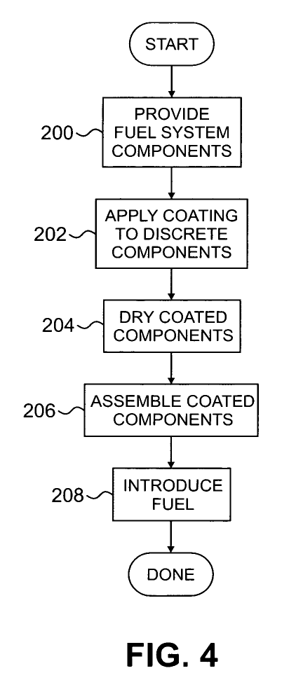

FIG. 4 is a flow chart of another embodiment of a method of making the fuel system 14. In this embodiment, components of the fuel system 14 are provided in at least partially unassembled state (step 200). In other words, the fuel system 14 is not fully assembled, but rather discrete components of the fuel system 14 are available essentially individually, though it is possible for some components to be assembled together (e.g., certain small parts can be connected together). Next, the coating 30 is applied to the discrete components of the fuel system 14 (step 202). Coating application at step 202 can be accomplished through spraying, dipping or other suitable processes, and can be performed at approximately room temperature. The coating 30 can be applied to components of the fuel system 14 individually, or to a group of components essentially simultaneously (e.g., in a batch dipping process). The coating 30 is then dried after application (step 204). Next the coated components are assembled together to define the completed fuel system 14 (step 206), and the fuel 32 can be introduced to the fuel system 14 (step 208). Operation of the fuel system 14, the gas turbine engine 12 and the aircraft 10 can then begin. It should be noted that the method of making the fuel system 14 described with respect to FIG. 4 can optionally include additional steps not specifically mentioned.

Those of ordinary skill in the art will appreciate that the present invention provides numerous benefits and advantages. For example, in addition to the benefits and advantages discussed above, the present invention can help aircraft fuel systems achieve operating temperatures of at least approximately 135° C. (275° F.) while also helping to provide approximately 20,000 or more operating hour overhaul limits. A coated fuel system according to the present invention can help reduce undesirable coking, and can help permit fuel system operating temperatures that would otherwise generate an unacceptable level of carbonaceous deposits and fouling of the fuel system. Moreover, use of a coating having a fluorine functional functional group and a silane functional group according to the present invention helps reduce any accumulation of carbonaceous materials on fuel system components, and allows for relatively thinner coating thicknesses than with other PTFE materials such as Teflon® brand coatings. Furthermore, the present invention can help enable the use of relatively small and light heat exchangers.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims. For example, the present invention can be applied to fuel systems of nearly any type of combustion engine, such as shipboard diesel engines for marine applications.

1. A fuel system for delivering fuel to an engine, the system comprising:
a fuel tank;
a hot section in fluid communication with the fuel tank for delivering fuel for combustion by the engine; and
a coating applied to at least a portion of the hot section for reducing fuel coking, wherein the coating comprises:
a fluorine functional group; and
a silane functional group.

2. The system of claim 1, wherein the hot section is configured to operate at about 135° C. (275° F.).

3. The system of claim 1, wherein the hot section is configured to operate at about 135° C. (275° F.) or hotter.

4. The system of claim 1, wherein the hot section comprises:
a fuel/oil heat exchanger;
a valve;
a filter; and
a conduit, wherein the fuel/oil heat exchanger, the valve and the filter are in fluid communication with each other.

5. A method comprising:
assembling fuel system components for a gas turbine engine;
flushing a coating compound through at least a portion of the assembled fuel system components, wherein the coating compound comprises a fluorine functional group and a silane functional group, and wherein flushing causes at least a portion of the coating compound to attach to exposed surfaces of the assembled fuel system components; and
purging the assembled fuel system components to remove an excess portion of the coating compound.

6. The method of claim 5, wherein the step of flushing a coating compound through at least a portion of the assembled fuel system components comprises flushing the coating compound through a hot section of the assembled fuel system.

7. The method of claim 5, wherein the step of assembling fuel system components includes installing a filter, such that the filter is coated during the step of flushing a coating compound through at least a portion of the assembled fuel system components.

8. The method of claim 5, wherein the step of purging the assembled fuel system components further dries the portion of the coating compound attached to exposed surfaces of the assembled fuel system components.

9. The method of claim 5, wherein the step of purging the assembled fuel system components is performed at room temperature.

10. The method of claim 5, wherein the step of flushing a coating compound through at least a portion of the assembled fuel system components causes at least a portion of the coating compound to attach to exposed surfaces of a filter, a valve, and a fuel/oil heat exchanger.

11. The method of claim 5 and further comprising:
after purging, introducing fuel into the assembled fuel system components; and
operating the fuel system at an operating temperature of at least about 135° C. (275° F.).

12. A method comprising:
providing discrete fuel system components for a gas turbine engine;
applying a coating compound to at least a portion of each of the discrete fuel system components, wherein the coating compound comprises a fluorine functional group and a silane functional group, and wherein the coating compound attaches to exposed surfaces of each of the discrete fuel system components;
drying the coating compound attached to the discrete fuel system components; and
assembling the coated discrete fuel system components together in fluid communication with each other.

13. The method of claim 12, wherein the step of applying a coating compound to at least a portion of each of the discrete fuel system components comprises dipping the discrete fuel system components into the coating compound.

14. The method of claim 12, wherein the step of applying a coating compound to at least a portion of each of the discrete fuel system components comprises spraying the coating compound onto at least portions of the discrete fuel system components.

15. The method of claim 12, wherein the step of applying the coating compound to the discrete fuel system components is performed at room temperature.

16. The method of claim 12, wherein the coating compound is applied to discrete fuel system components of a hot section of the fuel system.

17. The method of claim 16, wherein the coating compound is applied to a filter in the hot section.

18. The method of claim 16, wherein the coating compound is applied to a valve in the hot section.

19. The method of claim 16, wherein the coating compound is applied to a conduit in the hot section.

20. The method of claim 12 and further comprising:
after assembling the coated discrete fuel system components together, introducing fuel into the coated assembled fuel system components; and
operating the fuel system at an operating temperature of at least about 135° C. (275° F.).

21. A fuel system for delivering fuel to a combustor of a gas turbine engine, the system comprising:
a fuel tank;
a hot section in fluid communication with the fuel tank for delivering fuel to the combustor, wherein the hot section includes a metallic component; and
a coating applied to at least a portion of the hot section to provide a barrier between the fuel and the metallic component in the hot section for reducing fuel coking, wherein the coating is selected from the group consisting of: a fluorinated silane material, a fluorochemical acrylate material, and low molecular weight polytetrafluoroethylene.
